(19) United States
(12) Patent Application Publication
(10) Pub. No.: US 2013/0260138 A1
(43) Pub. Date: Oct. 3, 2013

(54) OPTICAL HARDENED FILM AND METHOD OF PRODUCING THE SAME

(71) Applicants: Yuesheng Shen, Baoding City (CN); Baoliang Zhao, Baoding City (CN); Xinli Huo, Baoding City (CN); Xuliang Wang, Baoding City (CN)

(72) Inventors: Yuesheng Shen, Baoding City (CN); Baoliang Zhao, Baoding City (CN); Xinli Huo, Baoding City (CN); Xuliang Wang, Baoding City (CN)

(21) Appl. No.: 13/990,199

(22) PCT Filed: Nov. 7, 2011
(86) PCT No.: PCT/CN11/81874

§ 371 Date: May 29, 2013

(30) Foreign Application Priority Data
Nov. 30, 2010 (CN) 201010566198.1

(51) Int. Cl. G02B 1/10

(52) U.S. Cl. CPC G02B 1/10
USPC 428/327; 428/331; 428/329; 428/330; 428/328; 427/517

(57) ABSTRACT

An optical hardened film and method of making same is provided, which comprises a substrate, and a hardened coating layer formed from a photohardenable coating composition applied onto the substrate, wherein the photohardenable coating composition consists of the following components: (1) 20 to 60 wt % of an acrylate-based compound with a functionality of 1 to 3; (2) 40 to 80 wt % of a hydroxyl-containing or amino-containing oligomer with a functionality of 4 to 10; (3) 1 to 30 wt % of nanoparticles having a particle size of 5 to 50 nm and being ones selected from the group consisting of silica, aluminum oxide, barium sulfate, titanium dioxide and methyl methacrylate; and (4) 0.1 to 8 wt % of a photoinitiator; wherein the above weight percentages are each based on the total weight of the components (1) and (2).

### TECHNICAL FIELD

The present invention relates to display technology, more particularly, to an optical hardened film and a method of producing the same.

### BACKGROUND ART

In recent years, with the rapid development of flat panel display technology, the display devices gradually tend to become smaller in volume, lighter in weight and higher in fidelity. Liquid crystal display devices and organic light emitting diodes, among others, are of most interest, because due to the advantages thereof including low voltage driven, low power consumption, portability, high display quality, mass-producibility, etc., they have been widely used in applications such as mobile phones, PDAs, calculators, desktop or portable computers, digital cameras, car navigation systems, and so on.

Either for liquid crystal display devices or organic light emitting diodes, in the technology of manufacturing of optical assemblies of flat panel display, it needs to use optical film materials with improved optical and physical properties so as to obtain the optical assemblies of flat panel display with required characteristics. As such optical film materials, it is desired to have performances including high transmittance, low haze, high scratch-resistance and strong corrosion-resistance. For example, when being applied in a touch-sensing-type liquid crystal display device, it is desired that the optical film material can protect the display's interface from being impaired by frequent external touches while using the device. Chinese Patent Application No. 200310101950.5, entitled “Optical Coated Laminate and Method of Producing the Same” (published on Apr. 27, 2005), discloses an optical coated laminate, and the main objective thereof is to form an optical film having a low birefractive index, high transmittance, low turbidity, and having a resistance to chemical solvents, by applying a photohardenable coating composition onto a substrate. However, it has been found that the resultant product has disadvantages including low scratch-resistance and poor resistance to acids and alkalis. Therefore, such product could not fulfill the application requirements of the touch-sensing-type liquid crystal display devices and would shorten the service life of optical display devices.

### SUMMARY OF THE INVENTION

The present invention is carried out in view of the defects in the prior art as described above, and the objects thereof are to provide an optical hardened film with high hardness, good resistance to acids and alkalis, simultaneously with high light transmittance and good solvent-resistance, and to provide a method for producing such optical hardened film.

One object of the present invention can be achieved by the following technical solutions:

An optical hardened film, comprising a substrate and a hardened coating layer formed from a photohardenable coating composition and applied onto the substrate, wherein said photohardenable coating composition consists of the following components:
(1) 20 to 60 wt % of an acrylate-based compound with a functionality of 1 to 3;
(2) 40 to 80 wt % of a hydroxyl-containing or amino-containing oligomer with a functionality of 4 to 10;
(3) 1 to 30 wt % of nanoparticles having a particle size of 5 to 50 nm and being ones selected from the group consisting of silica (SiO₂), aluminum oxide (Al₂O₃), barium sulfate (BaSO₄), titanium dioxide (TiO₂) and methyl methacrylate; and
(4) 0.1 to 8 wt % of a photoinitiator;

wherein the above weight percentages are each based on the total weight of the above components (1) and (2).

Said acrylate-based compound may be at least one selected from the group consisting of 2-hydroxyethyl methacrylate, acrylamide, 1,6-hexanediol dimethacrylate, 1,6-hexanediol diacrylate, ethylene glycol diacrylate, triethylene glycol diacrylate, tripropylene glycol diacrylate, neopentyl glycol diacrylate, trimethylolpropane triacrylate, trimethylolpentane trimethacrylate, and trimethylolpropane pentaerythritol triacrylate.

Said oligomer may be at least one selected from the group consisting of polyurethane acrylates, silicone acrylates, epoxy acrylates, polyester acrylates, polyol acrylates and the like.

Said nanoparticles having a particle size of 5 to 50 nm may be silica.

Said hardened coating layer may have a thickness of 2 to 10 μm.

Also, another object of the present invention can be achieved by the following technical solutions:

A method of producing an optical hardened film, comprising the following steps: providing a substrate; and forming a coating layer from a photohardenable coating composition on a surface of the substrate, and hardening the coating layer by light irradiation to produce a hardened coating layer, wherein said photohardenable coating composition consists of the following components:
(1) 20 to 60 wt % of an acrylate-based compound with a functionality of 1 to 3;
(2) 40 to 80 wt % of a hydroxyl-containing or amino-containing oligomer with a functionality of 4 to 10;
(3) 1 to 30 wt % of nanoparticles having a particle size of 5 to 50 nm and being ones selected from the group consisting of silica, aluminum oxide, barium sulfate, titanium dioxide and methyl methacrylate; and
(4) 0.1 to 8 wt % of a photoinitiator;

wherein the above weight percentages are each based on the total weight of the components (1) and (2).

Said acrylate-based compound may be at least one selected from the group consisting of 2-hydroxyethyl methacrylate, acrylamide, 1,6-hexanediol dimethacrylate, 1,6-hexanediol diacrylate, ethylene glycol diacrylate, triethylene glycol diacrylate, tripropylene glycol diacrylate, neopentyl glycol diacrylate, trimethylolpropane triacrylate, trimethylolpentane trimethacrylate, and trimethylolpropane pentaerythritol triacrylate.

Said oligomer may be at least one selected from the group consisting of polyurethane acrylates, silicone acrylates, epoxy acrylates, polyester acrylates, and polyol acrylates.

Said nanoparticles having a particle size of 5 to 50 nm may be silica.

Said hardened coating layer may have a thickness of 2 to 10 μm.

Examples of processes for forming the coating layer on the surface of the substrate from the photohardenable coating composition include spray coating, dip coating, wire bar coating, flow coating, spin coating, screen printing, or strip coating.

As compared with the prior art, the hardened coating layer produced according to the present invention exhibits better resistance to acids and alkalis, and higher hardness, which are achieved by selection of the functionalities of the acrylate-based compounds and the hydroxyl-containing or amino-containing oligomers, respectively, and by adjustment of the proportion between the acrylate-based compounds with various functionalities and the hydroxyl-containing or amino-containing oligomers with various functionalities. Further, the hardened coating layer produced according to the present invention has a hardness of 3H or more by use of the nanoparticles having a particle size of 5 to 50 nm in the coating layer.

### DESCRIPTION OF SPECIFIC EMBODIMENTS

Hereinafter, the present invention will be described in detail with reference to the Examples, but the invention is not intended to be limited thereto.

### Example 1

1. Preparation of Photohardenable Coating Composition:

| | |
|---|---|
| neopentyl glycol diacrylate | 100 g |
| trimethylolpropane triacrylate | 100 g |
| silicone tetraacrylate | 700 g |
| polyurethane decaacrylate | 100 g |
| silica particles (particle size: 50 nm) | 10 g |
| 2-benzyl-2-N,N-dimethylamino-1- | 1 g |
| (4-morpholinophenyl)-1-butanone | |

To a mixing vessel, under the conditions that sunlight or UV irradiation were prevent and the relative humidity of air was less than 60%, each ingredient was added sequentially in the order and proportion as listed above, and every time after adding each ingredient, the obtained mixture was stirred sufficiently for 15 minutes. Finally, filtration was performed to remove impurities, whereby a photohardenable coating composition was formulated.

2. Preparation of Optical Hardened Film

A thermoplastic and flexible substrate (e.g., polyester film) was prepared in advance, and then the above formulated photohardenable coating composition was applied onto the surface of the substrate by wire bar coating. Then, the photohardenable coating composition on the substrate was subjected to light irradiation at an exposure energy of 800 mJ/cm² using a focused high pressure mercury lamp (200 W/cm), such that it was hardened to form an optical hardened film with a thickness of 2 μm on the substrate. The properties of the film were measured and the results are shown in Table 1 below.

### Example 2

1. Preparation of Photohardenable Coating Composition:

| | |
|---|---|
| 1,6-hexanediol dimethacrylate | 200 g |
| neopentyl glycol diacrylate | 200 g |
| trimethylolpropane pentaerythritol triacrylate | 200 g |
| polyurethane tetraacrylate | 400 g |
| barium sulphate (particle size: 15 nm) | 300 g |
| Photoinitiator 184 (hydroxycyclohexyl phenyl ketone) | 80 g |

To a mixing vessel, under the conditions that sunlight or UV irradiation were prevent and the relative humidity of air was less than 60%, each ingredient was added sequentially in the order and proportion as listed above, and every time after adding each ingredient, the obtained mixture was stirred sufficiently for 15 minutes. Finally, filtration was performed to remove impurities, whereby a photohardenable coating composition was formulated.

2. Preparation of Optical Hardened Film

A thermoplastic and flexible substrate (e.g., polyester film) was prepared in advance, and then the above formulated photohardenable coating composition was applied onto the surface of the substrate by wire bar coating. Then, the photohardenable coating composition on the substrate was subjected to light irradiation at an exposure energy of 1500 mJ/cm² using a focused high pressure mercury lamp (100 W/cm), such that it was hardened to form an optical hardened film with a thickness of 8 μm on the substrate. The properties of the film were measured and the results are shown in Table 1 below.

### Example 3

1. Preparation of Photohardenable Coating Composition:

| | |
|---|---|
| trimethylolpropane pentaerythritol triacrylate | 400 g |
| polyurethane hexaacrylate | 600 g |
| methyl methacrylate (particle size: 20 nm) | 100 g |
| Photoinitiator 184 (hydroxycyclohexyl phenyl ketone) | 20 g |

To a mixing vessel, under the conditions that sunlight or UV irradiation were prevent and the relative humidity of air was less than 60%, each ingredient was added sequentially in the order and proportion as listed above, and every time after adding each ingredient, the obtained mixture was stirred sufficiently for 15 minutes. Finally, filtration was performed to remove impurities, whereby a photohardenable coating composition was formulated.

2. Preparation of Optical Hardened Film

A thermoplastic and flexible substrate (e.g., polyester film) was prepared in advance, and then the above formulated photohardenable coating composition was applied onto the surface of the substrate by wire bar coating. Then, the photohardenable coating composition on the substrate was subjected to light irradiation at an exposure energy of 1500 mJ/cm² using a focused high pressure mercury lamp (100 W/cm), such that it was hardened to form an optical hardened film with a thickness of 5 μm on the substrate. The properties of the film were measured and the results are shown in Table 1 below.

### Example 4

1. Preparation of Photohardenable Coating Composition:

| | |
|---|---|
| ethylene glycol diacrylate | 300 g |
| trimethylolpropane pentaerythritol triacrylate | 200 g |
| polyurethane hexaacrylate | 500 g |
| silica (particle size: 5 nm) | 200 g |
| 2,4,6-(trimethylbenzoyl)diphenylphosphine oxide | 40 g |

To a mixing vessel, under the conditions that sunlight or UV irradiation were prevent and the relative humidity of air was less than 60%, each ingredient was added sequentially in the order and proportion as listed above, and every time after adding each ingredient, the obtained mixture was stirred sufficiently for 15 minutes. Finally, filtration was performed to remove impurities, whereby a photohardenable coating composition was formulated.

2. Preparation of Optical Hardened Film

A thermoplastic and flexible substrate (e.g., polyester film) was prepared in advance, and then the above formulated photohardenable coating composition was applied onto the surface of the substrate by wire bar coating. Then, the photohardenable coating composition on the substrate was subjected to light irradiation at an exposure energy of 1500 mJ/cm² using a focused high pressure mercury lamp (100 W/cm), such that it was hardened to form an optical hardened film with a thickness of 10 μm on the substrate. The properties of the film were measured and the results are shown in Table 1 below.

### Example 5

1. Preparation of Photohardenable Coating Composition:

| | |
|---|---|
| ethylene glycol diacrylate | 100 g |
| trimethylolpentane trimethacrylate | 200 g |
| polyurethane octaacrylate | 700 g |
| silica (particle size: 30 nm) | 150 g |
| 2-hydroxy-2-methyl-1-phenyl-propanone | 60 g |

To a mixing vessel, under the conditions that sunlight or UV irradiation were prevent and the relative humidity of air was less than 60%, each ingredient was added sequentially in the order and proportion as listed above, and every time after adding each ingredient, the obtained mixture was stirred sufficiently for 15 minutes. Finally, filtration was performed to remove impurities, whereby a photohardenable coating composition was formulated.

2. Preparation of Optical Hardened Film

A thermoplastic and flexible substrate (e.g., polyester film) was prepared in advance, and then the above formulated photohardenable coating composition was applied onto the surface of the substrate by wire bar coating. Then, the photohardenable coating composition on the substrate was subjected to light irradiation at an exposure energy of 1500 mJ/cm² using a focused high pressure mercury lamp (100 W/cm), such that it was hardened to form an optical hardened film with a thickness of 3 μm on the substrate. The properties of the film were measured and the results are shown in Table 1 below.

TABLE 1

| | | | | | Light |
|---|---|---|---|---|---|
| | | | | | transmittance/ |
| | | Hard- | Solvent | Acid/alkali | haze |
| | Adhesion | ness | resistance | resistance | (%) |
| Example 1 | ⊚ | 3H | ⊚ | ⊚ | 91.6/1.1 |
| Example 2 | ⊚ | 5H | ⊚ | ⊚ | 91.8/1.2 |
| Example 3 | ⊚ | 5H | ⊚ | ⊚ | 92/1.4 |
| Example 4 | ⊚ | 4H | ⊚ | ⊚ | 91.3/1.5 |
| Example 5 | ⊚ | 4H | ⊚ | ⊚ | 91.3/1.5 |

1. Adhesion Test

The adhesion test was carried out in accordance with GB/T9286-1998 (“Paints and Varnishes—Cross cut test for films”) in the National Standards of China. If a test result of “100/100” was obtained, then it was assessed as “pass” and represented by “⊚” in Table 1.

2. Hardness Test

The hardness test was carried out in accordance with GB/T6739-2006 (“Paints and Varnishes—Determination of film hardness by pencil test”) in the National Standards of China.

3. Solvent Resistance Test

The coated samples were soaked in ethanol, isopropanol, ethyl acetate, butyl acetate, methyl ethyl ketone, acetone, and toluene, respectively, each for 10 minutes at room temperature, then taken out, washed with distilled water and dried with filter paper. Then, the samples were observed visually to determine if whitening and corrosion occurred on the surface thereof or if there was any deformation or warping. If none of those phenomena occurred, then the test result was assessed as “pass” and represented by “⊚” in Table 1.

4. Acid/Alkali-Resistance Test

For the acid-resistance test, the coated samples were placed in a solution formulated with concentrated nitric acid, fuming hydrochloric acid and water (mass ratio: 1:50:50) at 50 for 5 seconds, then taken out, washed thoroughly with distilled water and dried with filter paper. Then, the adhesion was measured. If a test result of “100/100” was obtained, then it was assessed as “pass”. For the alkali-resistance test, the coated samples were placed in 3% by mass of a NaOH aqueous solution for 20 seconds, then taken out, washed thoroughly with distilled water and dried with filter paper. Then, the adhesion was measured. If a test result of “100/100” was obtained, then it was assessed as “pass”. “Pass” for both of the acid-resistance test and alkali-resistance test is represented by “⊚” in Table 1.

5. Transmittance and Haze Test

The transmittance and haze test was carried out using WGT-S light transmittance/haze meter (manufactured by Shanghai Precision & Scientific Instrument Co., Ltd. in China).

It should be understood that the embodiments and examples described above are merely illustrative ones provided for the purpose of explaining the mechanism of the present invention, but the invention is not intended to be limited thereto. Various modifications and alterations of this invention will become apparent to those skilled in the art without departing from the spirit and scope of this invention, and therefore, are also within the scope of the invention.

1. An optical hardened film, comprising:
a substrate, and
a hardened coating layer formed from a photohardenable coating composition and applied onto the substrate, wherein said photohardenable coating composition consists of the following components:
(1) 20 to 60 wt % of an acrylate-based compound with a functionality of 1 to 3;
(2) 40 to 80 wt % of a hydroxyl-containing or amino-containing oligomer with a functionality of 4 to 10;
(3) 1 to 30 wt % of nanoparticles having a particle size of 5 to 50 nm and being ones selected from the group consisting of silica, aluminum oxide, barium sulfate, titanium dioxide and methyl methacrylate; and
(4) 0.1 to 8 wt % of a photoinitiator;
wherein the above weight percentages are each based on the total weight of the components (1) and (2).

2. The optical hardened film according to claim 1, wherein said acrylate-based compound is at least one selected from the group consisting of 2-hydroxyethyl methacrylate, acrylamide, 1,6-hexanediol dimethacrylate, 1,6-hexanediol diacrylate, ethylene glycol diacrylate, triethylene glycol diacrylate, tripropylene glycol diacrylate, neopentyl glycol diacrylate, trimethylolpropane triacrylate, trimethylolpentane trimethacrylate, and trimethylolpropane pentaerythritol triacrylate.

3. The optical hardened film according to claim 1, wherein said oligomer is at least one selected from the group consisting of polyurethane acrylates, silicone acrylates, epoxy acrylates, polyester acrylates, and polyol acrylates.

4. The optical hardened film according to claim 3, wherein said nanoparticles having a particle size of 5 to 50 nm are silica.

5. The optical hardened film according to claim 1, wherein said hardened coating layer has a thickness of 2 to 10 μm.

6. A method of producing an optical hardened film, comprising:
providing a substrate;
forming a coating layer from a photohardenable coating composition on a surface of the substrate, and
hardening the coating layer by light irradiation to produce a hardened coating layer, wherein said photohardenable coating composition consists of the following components:
(1) 20 to 60 wt % of an acrylate-based compound with a functionality of 1 to 3;
(2) 40 to 80 wt % of a hydroxyl-containing or amino-containing oligomer with a functionality of 4 to 10;
(3) 1 to 30 wt % of nanoparticles having a particle size of 5 to 50 nm and being ones selected from the group consisting of silica, aluminum oxide, barium sulfate, titanium dioxide and methyl methacrylate; and
(4) 0.1 to 8 wt % of a photoinitiator;
wherein the above weight percentages are each based on the total weight of the components (1) and (2).

7. The method of producing an optical hardened film according to claim 6, wherein said acrylate-based compound is at least one selected from the group consisting of 2-hydroxyethyl methacrylate, acrylamide, 1,6-hexanediol dimethacrylate, 1,6-hexanediol diacrylate, ethylene glycol diacrylate, triethylene glycol diacrylate, tripropylene glycol diacrylate, neopentyl glycol diacrylate, trimethylolpropane triacrylate, trimethylolpentane trimethacrylate, and trimethylolpropane pentaerythritol triacrylate.

8. The method of producing an optical hardened film according to claim 6, wherein said oligomer is at least one selected from the group consisting of polyurethane acrylates, silicone acrylates, epoxy acrylates, polyester acrylates, and polyol acrylates.

9. The method of producing an optical hardened film according to claim 8, wherein said nanoparticles having a particle size of 5 to 50 nm are silica.

10. The method of producing an optical hardened film according to claim 6, wherein said hardened coating layer has a thickness of 2 to 10 μm.

11. The optical hardened film according to claim 2, wherein said oligomer is at least one selected from the group consisting of polyurethane acrylates, silicone acrylates, epoxy acrylates, polyester acrylates, and polyol acrylates.

12. The optical hardened film according to claim 11, wherein said nanoparticles having a particle size of 5 to 50 nm are silica.

13. The method of producing an optical hardened film according to claim 7, wherein said oligomer is at least one selected from the group consisting of polyurethane acrylates, silicone acrylates, epoxy acrylates, polyester acrylates, and polyol acrylates.

14. The method of producing an optical hardened film according to claim 13, wherein said nanoparticles having a particle size of 5 to 50 nm are silica.
